(19) United States
(12) Patent Application Publication
(10) Pub. No.: US 2008/0162281 A1
(43) Pub. Date: Jul. 3, 2008

(54) System for creating media objects including advertisements

(76) Inventors: Marc Eliot Davis, San Francisco, CA (US); Ronald George Martinez, San Fancisco, CA (US); Chris Theodore Kalaboukis, Los Gatos, CA (US)

Correspondence Address: BRINKS HOFER GILSON & LIONE / YAHOO! OVERTURE, P.O. BOX 10395, CHICAGO, IL, 60610, US

(21) Appl. No.: 11/646,881

(22) Filed: Dec. 28, 2006

(51) Int. Cl. G06Q 30/00

(52) U.S. Cl. 705/14

(57) ABSTRACT

A system is disclosed for creating a media object. The system may include a database for maintaining a first set of information including a plurality of media objects, each of the plurality of media objects having an associated object content, and a second set of information including a plurality of advertisement, each of the plurality of advertisements having an associated advertisement content. The system may also include a media creation server in communication with the database and configured to (1) determine, based on the object content and the advertisement content, if at least one media object is appropriate for inclusion in a new media object including a selected one of the plurality of advertisement objects, and (2) create a new media object including the selected advertisement and the determined appropriate media object.

### BACKGROUND

1. Technical Field

This application relates to media delivery systems. More particularly, this application relates to a flexible system for creating and delivering new media objects with an optimal combination of content and advertisements.

2. Related Art

Recent technological advances have greatly increased the number of ways in which media is created and consumed, resulting in media, such as movies and audio files, being generated by millions of users worldwide. Moreover, the users now creating media can vary dramatically, from professional media creators to amateurs, resulting in media that varies just as widely in format.

Additionally, the number of devices capable of accessing the Internet has also dramatically increased. Today, users may access the Internet using a wide variety of devices, such as personal computers, cell phones, personal digital assistants, and the like which may utilize different networking technologies to connect to the Internet. The portability of the device and/or connection type has become an increasingly important concern for users, and has enabled users to consume the media in record numbers and in a wide variety of ways.

While these advancements may have made it easier for users to create and consume media, it has made it increasingly difficult for advertisers to strategically place advertisements in the newly created media for multiple reasons. First, the nonstandard format of the media makes it difficult to place an advertisement at an optimal place within the media. Second, the sheer number of the created media may make it difficult for an advertiser to review all the media and target advertisements for particular media.

As a result, advertisers may be limited in their ability to take full advantage of the recent proliferation in media creation and delivery systems.

### BRIEF SUMMARY

In one embodiment, a method for creating a media object is provided. The method may include receiving a first set of information including a plurality of media objects, each of the plurality of media objects having an associated object content, receiving a second set of information including a plurality of advertisement objects, each of the plurality of advertisement objects having an associated advertisement content, determining, based on the media object content and the advertisement content, if at least one media object is appropriate for inclusion in a new media object including at least one of the plurality of advertisement objects, and creating a new media object including the at least one advertisement object and the determined appropriate media object.

In another embodiment, a method for creating a media object is provided. The method may include receiving a first set of information including a media object, the media object including a plurality of media object portions, each of the plurality of media object portions having an associated content, receiving from an advertiser, a request for inclusion of an advertisement object in the media object, receiving a second set of information including the advertisement object, the advertisement having an associated advertisement content, revising, based on the media object content and the advertisement content, at least one media object portion, and creating a new media object including the at least one revised media object portion and the advertisement object.

In another embodiment, a system for creating a media object is provided. The system may include a database for maintaining a first set of information including a plurality of media objects, each of the plurality of media objects having an associated object content, and a second set of information including a plurality of advertisements, each of the plurality of advertisements having an associated advertisement content. The system may also include a media creation server in communication with the database and configured to (1) determine, based on the object content and the advertisement content, if at least one media object is appropriate for inclusion in a new media object including a selected one of the plurality of advertisement objects, and (2) create a new media object including the selected advertisement and the determined appropriate media object.

These and other embodiments and aspects are described with reference to the noted Figures and the below detailed description of the preferred embodiments.

### BRIEF DESCRIPTION OF THE DRAWINGS

FIG. 1 is a diagram of an exemplary architecture for creating and delivering media objects;

FIG. 2 is a diagram of various functional components of an exemplary media object creation and delivery server;

FIG. 3 is a flow chart of an exemplary method for analyzing media objects;

FIG. 4A is a flow chart of an exemplary method for creating a media map for a new media object based on the content of media objects and advertisement objects;

FIG. 4B is another flow chart of an exemplary method for creating a media map for a new media object based on the content of media objects and advertisement objects;

FIG. 5 is a flow chart of an exemplary method for creating a media map for a new media object based on user preferences and the content of media objects and advertisement objects;

FIG. 6 is a flow chart of an exemplary method for delivering a requested media object to a user;

FIG. 7 is a flow chart of an exemplary method for creating and delivering a media object to a user based on a user requested subject matter; and

FIG. 8 is flow chart of an exemplary method for creating a media map for a new media object based on the content and type of media objects and advertisement objects.

### DETAILED DESCRIPTION

Systems and methods, generally referred to as systems, are disclosed for creating media objects. Existing technologies may limit the manner in which advertisers are able to take advantage of the vast number of media objects being created today. The systems described herein may solve some of these problems by allowing a flexible way for allowing advertisers to place ads in relevant media of all shapes and sizes. Additionally, media may be edited to optimize the impact of an advertisement.

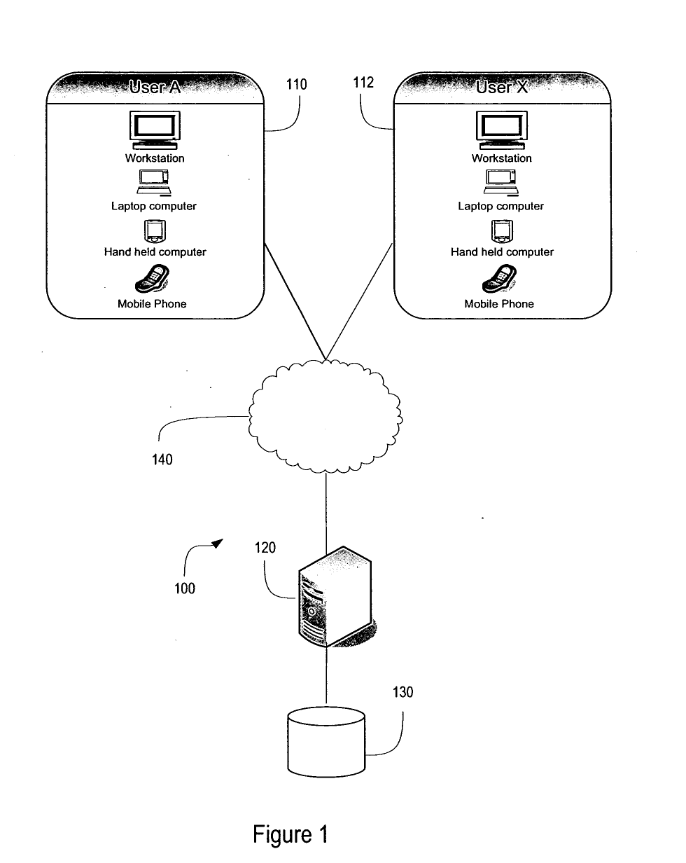

Referring now to the drawings, and initially to FIG. 1, an exemplary architecture 100 may be used for creating and delivering media objects. The architecture 100 may include a user A client system 110, a user X client system 112, a media object creation and delivery server 120, and a database 130. Although reference is now made to specific components of the system performing specific features, it should be apparent that such reference is exemplary, is not intended to limit the scope of the claims in any way, and that the functionalities described herein may be implemented in a virtually unlimited number of configurations.

The user A client system 110 may submit media objects and/or advertisement objects to the media object creation and delivery server 120 via the communications network 140. The communication network 140 may be any private or public communication network. The user client A system 110 may connect to the media object creating and delivery server 120 via the Internet using a standard browser application. A browser based implementation allows system features to be accessible regardless of the underlying platform of the user A client system 110. For example, the user A client system 110 may be a workstation computer, laptop computer, handheld computer, cell phone, mobile messaging device, or the like which may all utilize different hardware and/or software packages. Alternatively, or additionally, the user A client system 110 may connect to the search engine server 120 using a stand-alone application which may be either platform dependent or platform independent. Other methods may be used to implement the user A client system 110.

The user X client system 112 may request media objects from the media creation and delivery server 120 via the communications network 140. Media objects may be requested in any manner, such as by object name or content subject matter. Other methods of requesting a media object or media object scenes may also be used. The communication network 140 may be any private or public communication network. The user client X system 112 may connect to the media object creation and delivery server 120 via the Internet using a standard browser application. A browser based implementation allows system features to be accessible regardless of the underlying platform of the user X client system 112. For example, the user X client system 112 may be a workstation computer, laptop computer, handheld computer, cell phone, mobile messaging device, or the like which may all utilize different hardware and/or software packages. Alternatively, or additionally, the user X client system 112 may connect to the media creation and delivery server 120 using a stand-alone application which may be either platform dependent or platform independent. Other methods may be used to implement the user X client system 112.

The media object creation and delivery server 120 may receive the media object or advertisement object from the user A client system 110, and analyze the structure and content of the media object or advertisement object. The media object creation and delivery server 120 may also create new media objects based on the received media objects, media object scenes, and/or advertisement objects. For example, the media object creation and delivery server 120 may create a new media object by assembling a new media sequence around one or more advertisement objects. Alternatively, or additionally, the media object creation and delivery server 120 may create a new media object by revising an existing media object to support the insertion of one or more advertising objects. In either scenario, the media object creation and delivery server 120 may ensure audio, visual, and/or textual continuity, and/or brand and/or message continuity and effect, as described in more detail below.

Optionally, the content of the created media object may be revised in a variety of ways to ensure these continuities. For example, a media object may be revised by editing, scaling, cropping, rotating, or trimming the video, audio or text of the media object. Similarly, a media object may be revised by adjusting the rate of video/audio playback, inserting additional video, audio or text, overlaying additional video, audio, or text, and the like. Other methods of revising the content of a media object may also be used.

Additionally, the media creation and delivery server 120 may operate on the content of the created media object at various levels of granularity for multiple modalities. The modalities may include, for example, the full range of video, audio, textual, and graphical modalities. Such levels of granularity may include (in increasing granularity): an entire media production, media chapter (or section) media scene, media sequences, media shots, media layers, media moving regions, and media regions. Audio media objects can also include multiple channels or tracks and then finer grained segments of each of these, as described below. As used herein, a media object may refer to any level of granularity described herein and may include any combination of video, audio, visual, or textual data. Other levels of granularity of a media object may also be used.

The media object creation and delivery server 120 may also deliver the created media objects to the user X client system 112 in response to requests for media objects. The media object creation and delivery server 120 may also include a database 130 for storing the received media objects, advertisement objects, and created media objects. Additionally, the database 130 may also include information relating to the media objects, advertisement objects, and created media objects, such as metadata describing the author or owner of the media objects, advertisement objects, and created media objects, metadata describing the content and/or structure of the media objects, media object scenes, advertisement objects, and created media objects, user preferences and the like. Moreover, although figuratively attached to search engine server 120, database 130 may, in practice, distribute user-specific data elements (such as user preferences) to the user client system 110.

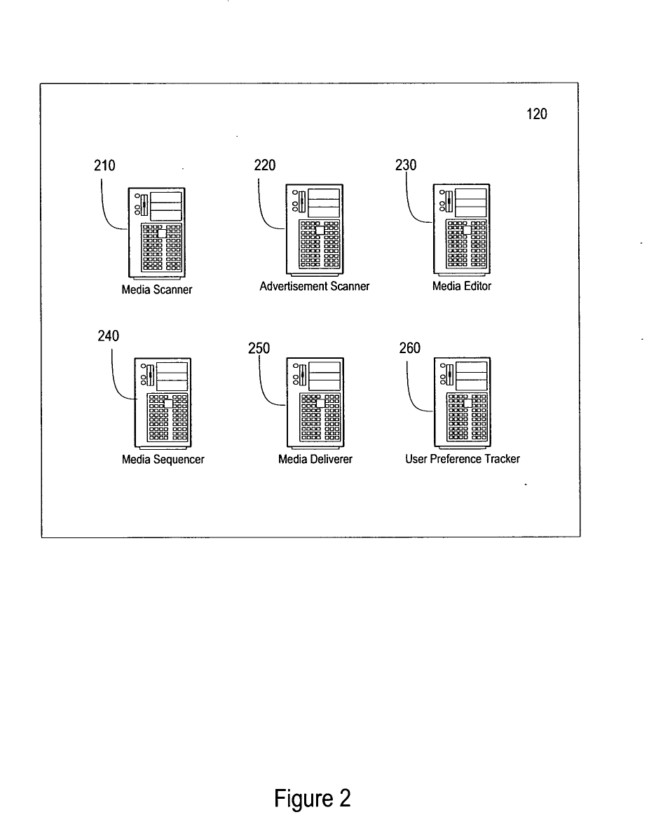

FIG. 2 is a diagram of various functional components of an exemplary media object creation and delivery server 120. The media object creation and delivery server 120 may include a media scanner 210, advertisement scanner 220, media editor 230, media sequencer 240, and media deliverer 250. Optionally, the media creation and delivery server 120 may include a user preference tracker 260. Although reference is now made to specific components of the system performing specific features, it should be apparent that such reference is exemplary, is not intended to limit the scope of the claims in any way, and that the functionalities described herein may be implemented in a virtually unlimited number of configurations.

The media scanner 210 may analyze the submitted media objects. The media objects may be analyzed to determine the structure and/or content of the particular media object. The media scanner 210 may be programmed to determine the content and/or structure of the media objects. Alternatively or additionally, the media scanner 210 may be configured to receive user input indicative of the content and/or structure of the media objects.

Each media object may have an associated structure that is determined by the media scanner. For example, each media object may include one or more media object portions. As used herein, the term “media object portion” means any unit of a media object, such as the various levels of granularity and modalities described above. Media object portions may be any length, and may be determined using any method. For example, the determined structure of a media object portion may be determined by noting known scene transition patterns, such as fade-ins, fadeouts, and the like. The structure may be determined programmatically or by a user. Other methods may also be used to determine the structure of a media object. As another example, each sentence or word of an audio media object may constitute a scene.

The determined media object portions may be categorized as required (or essential) or not required (non-essential) for the media object. For example, a media object representative of a movie may include portions that are necessary to the development of the movie plot. These portions may be tagged as required (or essential). Other portions that are not necessary to the development of the plot may be tagged not required (or non-essential). Similarly, offensive language, video, or images may be tagged as not required. Additionally, other portions categories may be used.

Additionally, the media scanner 210 may determine the content of each media object or portion (whether determined by the media scanner 210 or submitted with a media object). The media object or portion may be tagged with the determined content, such as by associating keywords describing the content with the media object or portion. For example, a video clip of a car driving through a forest that stops for a deer crossing the road may be tagged with the key words car, tree, forest, brakes, deer, outdoors, tires, insurance, and the like. More or less detail may be included. The content may be determined programmatically or by a user. For example, an image recognition program may be used to recognize various items in a video media object scene and create a list of words matching the determined content.

Optionally, the content of a media object or portion may be categorized, such as positive, negative, or neutral. Positive content may refer to any content that is treated positively in the underlying media object or portion. For example, if the media object or portion lauds a particular product, that product may be noted as positive content. Alternatively, if the media object or portion disparages a particular product, that product may be noted as negative content. If a particular content item is neither praised nor criticized, it may be noted as neutral content. Other categories of content may also be used.

Moreover, a particular media object or portion may include positive treatment of a first topic and negative treatment of a second topic. For example, one media object or portion may be positive for an insurance company and negative towards a car company. In such situations, each tag or keyword may be categorized as positive, negative, or neutral. Other levels of granularity in analyzing the content of a media object or portion may also be used.

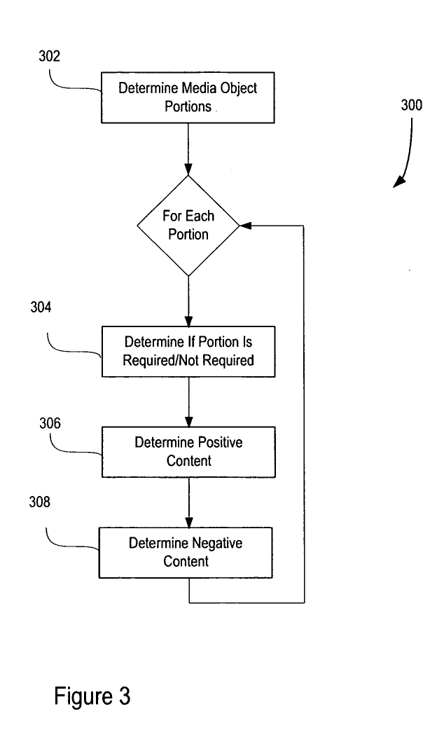

FIG. 3 is a flow chart of an exemplary method for analyzing media objects. Initially, media objects may be broken down into one or more media object portions at 302. The system may then determine the content of each determined media object portion, by determining if the portion is required or not required at 304, determining the positive content of a portion at 306, and determining the negative content of a portion at 308.

Referring again to FIG. 2, the advertisement scanner 220 may analyze the submitted advertisement objects to determine the structure and/or content of the particular media object or media object scene. Alternatively, the media creation and delivery server 120 may require that advertisement objects include only single advertisements, and it may be unnecessary to analyze the structure of an advertisement object. The advertisement scanner 220 may programmatically determine the content and/or structure of the advertisement objects. Alternatively or additionally, the advertisement scanner 220 may be configured to receive user input indicative of the content and/or structure of the advertisement objects. The advertisement may operate substantially similarly to the media scanner 210.

The media editor 230 may remove media object portions from a media object that have been tagged as not essential, as described above. The media editor 230 may also compile various media objects or portions based on a user request for a media object having a particular subject matter, as described in more detail below. Alternatively, or additionally, the media editor 230 may edit the content of a particular media object or portion to make the media object scene more appropriate for a particular advertisement object, as described above. This type of editing is similar to the process of removing offensive language from a particular movie in order to air that movie on network television. For example, negative treatment of a particular product may be removed from a particular media object or portion without eliminating required plot development. In other words, the media editor 230 may create a “clean” version (with respect to a particular tag or keyword) of the media object scene.

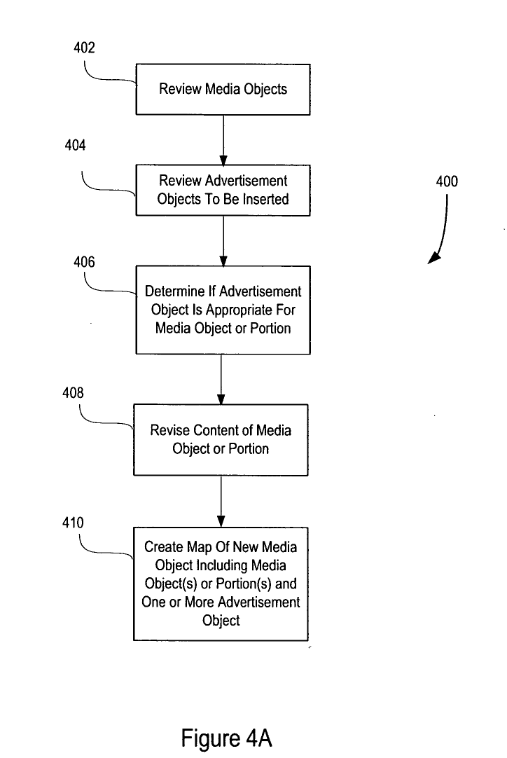

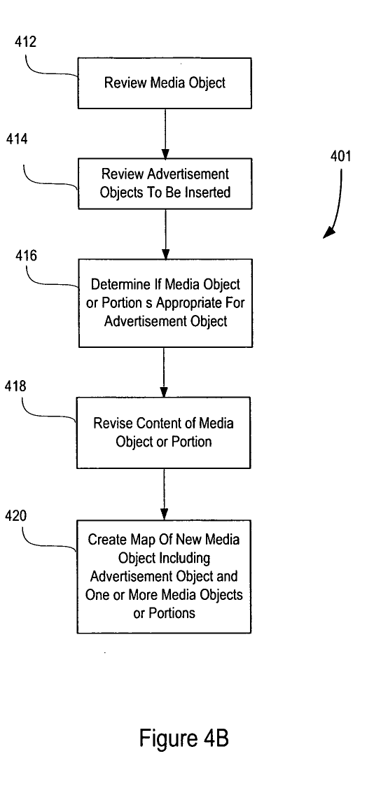

The media sequencer 240 may create a media map or sequence for a new media object based on the user requested media object. The media map or sequence may detail the order of one or more media objects or portions and advertisement objects. Referring also to FIG. 4A an exemplary method 400 for creating a media map for a new media object based on the content of a media object and advertisement objects. First, the requested structure and content of the request media object is analyzed at 402. At 404, the structure and/or content of advertisement objects is analyzed. The media sequencer 240 may determine if an advertisement is appropriate for inclusion in the new media object, and if so, which scene the advertisement should be placed next to at 406. An advertisement may be determined to be appropriate for a particular media object scene using any criteria. For example, an advertisement may be appropriate if the media object or portion includes positive content relating to the advertisement object content. Alternatively, or additionally, an advertisement may be appropriate if the media object or portion includes neutral content relating to the advertisement object content, or does not include negative content relating to the advertisement object content.

The requested media object (or portions thereof) may be revised to ensure audio, visual, and/or textual continuity, and/or brand and/or message continuity and effect at 408. For example, if a portion of a media object includes negative treatment of a particular subject matter, that portion of the media object may be removed to ensure brand continuity. Alternatively, or additionally, that portion of the media object may be revised to ensure brand continuity. For example, a video media object including a billboard advertising a first cola brand may be revised to advertise a second cola brand to ensure brand continuity with a particular advertisement object. Similarly, the content of a media object may be edited to ensure video, audio, visual, and/or textual continuity. For example, if a portion of a media object is removed or revised, it may be appropriate to edit the remaining portions of the media object to ensure video, audio, visual, and/or textual continuity.

Finally, a map of a new media object including the requested media object (or portions thereof) and one or more advertisement object is created at 410.

Referring to FIG. 4B, another exemplary method 401 for creating a media map for a new media object based on the content of media objects or portions and advertisement objects. First, the requested structure and content of the media objects or portions are analyzed at 412. At 414, the structure and/or content of advertisement objects is analyzed. The media sequencer 240 may determine if a media object or portion is appropriate for inclusion in a new media object that includes a particular advertisement object, and if so, where the advertisement should be placed in the new media object at 416. The media object or portion may be determined to be appropriate for a new media object including a particular advertisement object using any criteria. For example, a media object or portion may be appropriate if the media object or portion includes positive content relating to the advertisement object content. Alternatively, or additionally, a media object or portion may be appropriate if the media object or portion includes neutral content relating to the advertisement object content, or does not include negative content relating to the advertisement object content. Optionally, the content of the selected media object or portions may be revised to ensure video, audio, visual, and/or textual continuity, and/or brand and/or message continuity and effect at 418. Finally, a map of a new media object including the appropriate media object or portions and one or more advertisement object (including the specified advertisement object) is created at 420.

The media deliverer 250 may create a media object based on the created media map and deliver the created media object to the requesting user. The created media object may be delivered in any manner. For example, the media deliverer 250 may deliver a video media object by streaming the media object to the requesting user, or a may create a downloadable media object for downloading by the requesting user. Other delivery mechanisms may also be used.

Optionally, the media object creation and delivery server 120 may include a user preference tracker 260. The user preference tracker may track any number of explicit or implicit user preferences. Explicit user preferences may include user defined preferences, such as favorite teams, cars, etc. Implicit preferences may be determined based any number of factors, such as previously consumed media objects and other content. When the media object creation and delivery system 120 includes a user preference tracker 260, the preferences of a user requesting a media object may be used to determine the appropriateness of the inclusion of an advertisement object, or vice versa, in the creation of a new media object.

Alternatively or additionally, user preferences may be used to select content for inclusion in a particular media object. For example, user preferences may indicate that a user likes a particular genre of music, but not a particular artist. The user preferences may be utilized by the media object creation and delivery server 120 to deliver a random music video from a particular genre, excluding the undesired artist. Similarly, a user may be able to request an entirely random media object created by the media object creation and delivery server 120 that is based entirely on the user preferences.

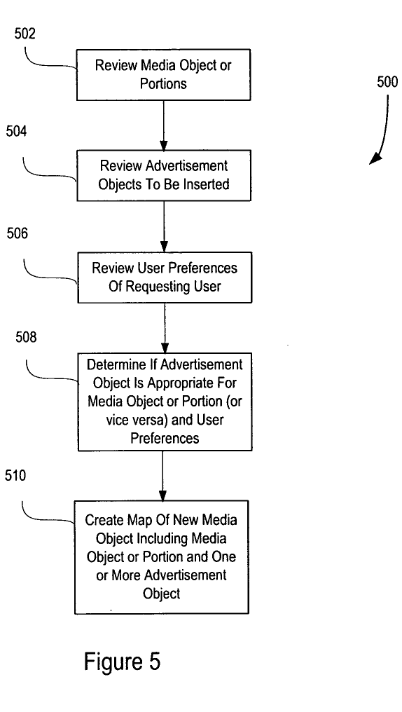

FIG. 5 is a flow chart of an exemplary method for creating a media map for a new media object based on user preferences and the content of media objects and advertisement objects. The requested structure and content of the request media object(s) is analyzed at 502. The structure and/or content of advertisement objects is analyzed at 504. User preferences are analyzed at 506. The media sequencer 240 may then determine if an advertisement is appropriate for inclusion in the new media object based on the user preferences, and if so, which portion of media object the advertisement should be placed next to at 508. A map of a new media object including the requested media object or portion and one or more advertisement object is created at 510.

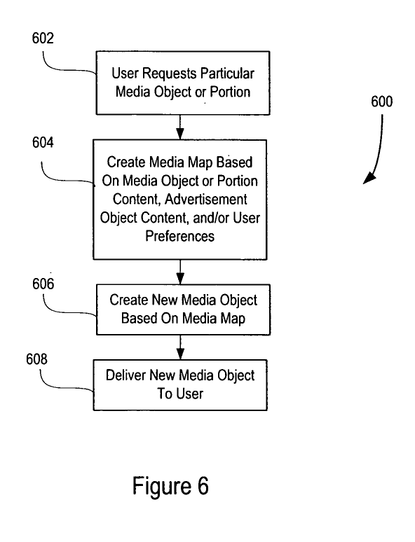

FIGS. 6-8 are exemplary flow charts illustrating various types of requests that may be serviced by the media creation and delivery server 120. FIG. 6 is an exemplary flow chart of an exemplary method for delivering a requested media object to a user. The user may request a particular media object, such as a particular movie, at 602. A media map including one or more media object portions and one or more advertisement objects may be created based on the determined content of the media object or portions and advertisement object(s) and/or user preferences at 604. A media object based on the map is created at 606 and delivered to the user at 608.

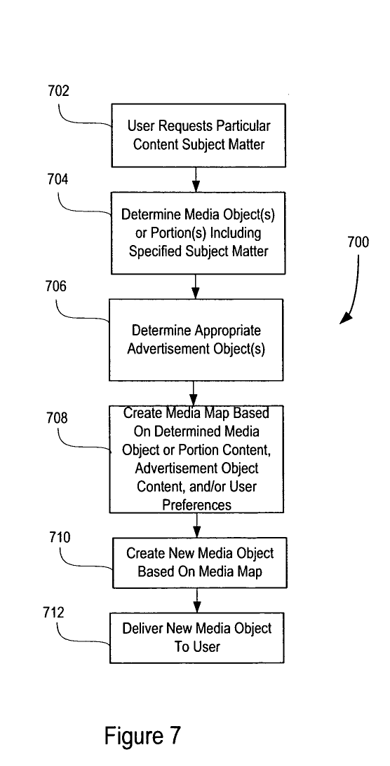

FIG. 7 is a flow chart of an exemplary method for creating and delivering a media object to a user based on a user requested subject matter. The user may request a media object that includes a specified subject matter, such as skateboard trick videos, at 602. The user may also specify any additionally criteria, such a total length of time for the media object. For example, the user may specify 15 minutes of skateboard trick videos be delivered to a mobile device while waiting for a doctor's appointment. One or more media objects or portions matching the specified criteria are determined at 704, and one or more advertisement objects matching the selected media object or portions are selected at 706. A media map may be created based on the determined media objects or portions and advertisement object(s) and/or user preferences at 708. A media object based on the map is created at 710 and delivered to the user at 712.

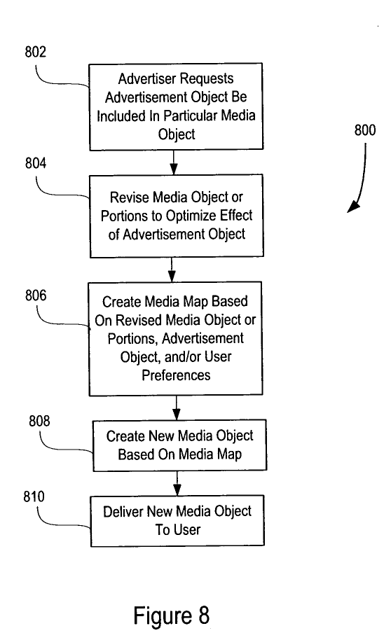

FIG. 8 is a flow chart of an exemplary method for creating a media map for a new media object based on the content and type of media object and advertisement objects. For example, an advertiser may want an advertisement object to be included with a particular movie. Initially, the advertiser request the inclusion of the advertisement object with a particular media object at 802. If necessary, the media object is then edited to optimize the effect of the advertisement object at 804. A media map may be created based on the requested media object and advertisement object(s) and/or user preferences at 806. Finally, a media object based on the map is created at 808 and delivered to the user at 810.

It is therefore intended that the foregoing detailed description be regarded as illustrative rather than limiting, and that it be understood that it is the following claims, including all equivalents, that are intended to define the spirit and scope of this invention.

1. A method for creating a media object, comprising:
receiving a first set of information including a plurality of media objects, each of the plurality of media objects having an associated object content;
receiving a second set of information including a plurality of advertisement objects, each of the plurality of advertisement objects having an associated advertisement content;
determining, based on the object content and the advertisement content, if at least one media object is appropriate for inclusion in a new media object including at least one of the plurality of advertisement objects; and
creating a new media object including the at least one advertisement object and the determined appropriate media object.

2. The method of claim 1, where the determining further includes determining if a media object is appropriate if the object content relates positively to the advertisement content.

3. The method of claim 1, where the determining further includes determining if a media object is appropriate if the object content does not related negatively to the advertisement content.

4. The method of claim 1, further comprising determining the object content for each of the media objects.

5. The method of claim 4, where the object content is determined automatically be a computer.

6. The method of claim 1, further comprising determining the advertisement content for the advertisement object.

7. The method of claim 1, further comprising:
receiving, from a user, a request for a media object having content including a specified subject matter; and
selecting media objects based on the specified subject matter.

8. The method of claim 1, further comprising determining that a media object is not appropriate for inclusion in a media object including at least one advertisement object.

9. The method of claim 1, where the object content further includes content categories.

10. The method of claim 9, further comprising categorizing object content as positive if it relates positively to a particular subject matter.

11. The method of claim 9, further comprising categorizing object content as negative if it relates negatively to a particular subject matter.

12. The method of claim 1, further comprising determining the structure of the media object.

13. A method for creating a media object, comprising:
receiving a first set of information including a media object, the media object including a plurality of media object portions, each of the plurality of media object portions having an associated portion content;
receiving from an advertiser, a request for inclusion of an advertisement object in the media object;
receiving a second set of information including the advertisement object, the advertisement having an associated advertisement content;
revising, based on the object content and the advertisement content, at least one media object portion; and
creating a new media object including the at least one revised media object and the advertisement object.

14. The method of claim 13, further comprising revising at least one media object portion if the object content relates negatively to the advertisement content.

15. The method of claim 13, further wherein the media object portions represent a segment of the media object selected from the group comprising media chapters, media scenes, media sequences, media shots, media layers, media moving regions, and media regions.

16. The method of claim 15, further comprising:
determining if a media object portion is required to be included in the created media object, and not including the associated media object scene only if the associated media object portion is not required.

17. A system for creating a media object, comprising:
a database for maintaining:
a first set of information including a plurality of media objects, each of the plurality of media objects having an associated object content, and
a second set of information including a plurality of advertisement, each of the plurality of advertisements having an associated advertisement content; and
a media creation server in communication with the database and configured to:
determine, based on the object content and the advertisement content, if at least one media object is appropriate for inclusion in a new media object including a selected one of the plurality of advertisement objects; and
create a new media object including the selected advertisement and the determined appropriate media object.

18. The system of claim 17, further comprising a media analyzer configured to determine the content and/or structure of the plurality of media objects.

19. The system of claim 17, further comprising:
a media sequencer configured to determine an order for the selected advertisement object and the determined appropriate media object, and where the media creation server is further operable to create the new media object based on the determined order.

20. The system of claim 17, further comprising a media deliverer configured to deliver the created media object to a user.
